(19) United States
(12) Patent Application Publication
(10) Pub. No.: US 2013/0063069 A1
(43) Pub. Date: Mar. 14, 2013

(54) APPARATUS AND METHOD OF DRIVING MOTOR WITH INITIAL COMPENSATION

(71) Applicant: Joo Yul KO, Hwaseong (KR)

(72) Inventor: Joo Yul KO, Hwaseong (KR)

(73) Assignee: SAMSUNG ELECTRO-MECHANICS CO., LTD.

(21) Appl. No.: 13/363,897

(22) Filed: Feb. 1, 2012

(30) Foreign Application Priority Data
Sep. 9, 2011 (KR) 10-2011-0092145

(51) Int. Cl. H02P 6/08

(52) U.S. Cl. 318/722

(57) ABSTRACT

There are provided an apparatus and a method for driving a motor with initial compensation. The apparatus for driving a motor includes a current detecting part detecting a voltage of a driving current flowing in the motor through an inverter supplying the driving current to the motor; a peak value detecting part detecting a peak value of the voltage detected by the current detecting part; an A/D converting part converting the voltage from the peak value detecting part into a digital signal; and a driving controlling part driving the motor for a predetermined initial driving period to compensate for an offset in the driving current based on the digital signal from the A/D converting part.

### CROSS-REFERENCE TO RELATED APPLICATIONS

This application claims the priority of Korean Patent Application No. 10-2011-0092145 filed on Sep. 9, 2011, in the Korean Intellectual Property Office, the disclosure of which is incorporated herein by reference.

### BACKGROUND OF THE INVENTION

1. Field of the Invention

The present invention relates to an apparatus and a method of driving a motor with initial compensation at the time of changing a motor or so as to cope with drift in motor characteristics.

2. Description of the Related Art

Generally, an apparatus for driving a motor may include a motor speed detection function so as to allow the motor to be driven at a desired speed and a protective function of stopping the motor from being driven when the driving current of the motor is an overcurrent.

For example, the motor driving apparatus may include a protective function of monitoring the driving current using a resistor to prevent an overcurrent.

The protective function may shut-down the driving apparatus in a case in which the driving current is determined as an overcurrent by detecting a peak current.

Meanwhile, the motor may cause current distribution, making the driving current variable, due to several factors occurring during the manufacturing thereof. In addition, drift in motor characteristics occurs when the motor is used for a long period of time, which may lead to the driving current being variable.

In order to reduce current distribution within the related art motor, a method of current trimming using an external resistor may be used, which can only be performed in the DC operation. Recently, in the case of a brushless DC (BLDC) motor, PWM control is used, and accordingly, there is a limitation in using the external device. Therefore, a need exists for a driving apparatus capable of reducing the current distribution within the motor, regardless of the above disadvantages.

Therefore, since the motor driving apparatus according to the related art does not provide initial compensation capable of reducing current distribution in the motor, it cannot appropriately cope with current distribution between motor samples or drift in motor characteristics.

### SUMMARY OF THE INVENTION

An aspect of the present invention is to provide an apparatus and a method of driving a motor with initial compensation at the time of changing a motor or so as to cope with drift in motor characteristics.

According to an aspect of the present invention, there is provided an apparatus for driving a motor, the apparatus including: a current detecting part detecting a voltage of a driving current flowing in the motor through an inverter supplying the driving current to the motor; a peak value detecting part detecting a peak value of the voltage detected by the current detecting part; an A/D converting part converting the voltage from the peak value detecting part into a digital signal; and a driving controlling part driving the motor for a predetermined initial driving period to compensate for an offset in the driving current based on the digital signal from the A/D converting part.

The current detecting part may include a resistor connected between the inverter and a ground so as to detect the current flowing to the ground through the inverter, and detect the voltage determined by a resistance value of the resistor and the current flowing in the resistor.

The peak value detecting part may include an envelope detector detecting an envelope of AC voltages detected by the current detecting part to thereby detect the peak value.

The peak value detecting part may include an integrator integrating AC voltages detected by the current detecting part to thereby detect the peak value.

The peak value detecting part may include an operational amplifier having a first input terminal and a second input terminal receiving the AC voltages detected by the current detecting part; and a capacitor connected between an output terminal of the operational amplifier and the second input terminal.

The driving controlling part may include a PWM controller controlling the driving of the motor for the initial driving period and compensating for the offset in the driving current with a previously set offset compensation value corresponding to a magnitude of the digital signal from the A/D converting part; and a gate driver generating a gate signal according to the controlling of the PWM controller and providing the gate signal to the inverter.

The initial driving period may be a period from motor driving initiation until a time at which a predetermined amount of motor revolutions is reached.

According to another aspect of the present invention, there is provided a method of driving a motor, the method including: detecting a voltage of a driving current flowing in the motor through an inverter supplying the driving current to the motor; detecting a peak value of the voltage detected by the current detecting part; performing A/D conversion by converting the voltage from the peak value detecting part into a digital signal; and controlling driving of the motor by driving the motor for a predetermined initial driving period and compensating for an offset in the driving current based on the digital signal.

The detecting of the voltage may include detecting the voltage determined by a resistance value of a resistor connected between the inverter and a ground and the current flowing in the resistor so as to detect the current flowing to the ground through the inverter.

The detecting of the peak value may include detecting the peak value using an envelope of AC voltages.

The detecting of the peak value may include detecting the peak value by integrating AC voltages.

The controlling of the driving of the motor may include controlling pulse width modulation (PWM) by controlling the driving of the motor for the initial driving period and compensating for the offset in the driving current with a previously set offset compensation value corresponding to a magnitude of the digital signal; and generating a gate signal according to the controlling of PWM and providing the gate signal to the inverter.

The initial driving period may be a period from motor driving initiation until a time at which a predetermined amount of motor revolutions is reached.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram illustrating an apparatus for driving a motor according to a first embodiment of the present invention;

FIG. 2 is a flowchart illustrating a method of driving a motor according to a second embodiment of the present invention; and

FIG. 3 is a waveform diagram illustrating a driving operation of the motor according to the first and second embodiments of the present invention.

### DETAILED DESCRIPTION OF THE PREFERRED EMBODIMENT

Exemplary embodiments of the present invention will now be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the same reference numerals will be used to designate the same or like components.

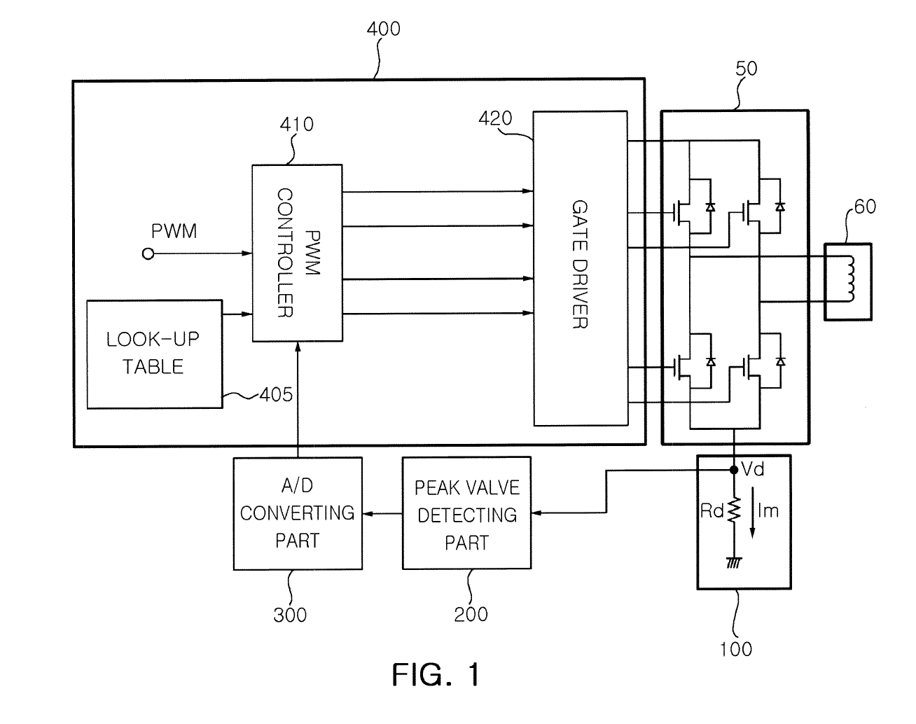

FIG. 1 is a block diagram illustrating an apparatus for driving a motor according to a first embodiment of the present invention.

Referring to FIG. 1, an apparatus for driving a motor according to a first embodiment of the present invention may include a current detecting part 100 detecting a voltage of a driving current flowing in a motor 60 through an inverter 50 supplying the driving current, a peak value detecting part 200 detecting a peak value of the voltage detected by the current detecting part 100, an A/D converting part 300 converting the voltage from the peak value detecting part 200 into a digital signal, and a driving controlling part 400 driving the motor 60 for a predetermined initial driving period AT from motor driving initiation until a time at which a predetermined amount of motor revolutions is reached, to compensate for an offset in the motor driving current based on the digital signal from the A/D converting part 300.

First, the inverter 50 supplies a driving current to the motor 60 for a predetermined initial driving period AT according to the controlling of the driving controlling part 400, such that the motor 60 is driven. Here, the initial driving period AT may be a period from motor driving initiation until a time at which a predetermined amount of motor revolutions is reached. For example, the revolution of the motor 60 necessary for offset compensation may be at least one revolution, and therefore, two or three revolutions may be implemented.

At this time, the current detecting part 100 may detect a voltage corresponding to the driving current flowing in the motor 60 through the inverter 50 supplying the driving current to the motor 60.

As an example, the current detecting part 100 may include a resistor Rd connected between the inverter 50 and a ground so as to detect a current Im flowing to the ground through inverter 50. By the use of the resistor Rd, a voltage Vd may be detected as Vd=Rd*Im using a resistance value of the resistor Rd and the current Im flowing in the resistor Rd.

Next, the peak value detecting part 200 detects a peak value of the voltage detected by the current detecting part 100 and provides the peak value to the A/D converting part 300.

Here, the peak value detecting part 200 may be implemented as a circuit capable of detecting the peak value, for example, an envelope detector or an integrator.

For example, when the peak value detecting part 200 is implemented as the envelope detector, the peak value may be detected from an envelope of AC voltages detected by the current detecting part 100.

As another example, when the peak value detecting part 200 is implemented as the integrator, the peak value may be detected by integrating the AC voltages detected by the current detecting part 100.

In the case in which the peak value detecting part 200 is implemented as the integrator, the peak value detecting part 200 may include an operational amplifier and a capacitor. Such an integral configuration, including the operational amplifier and the capacitor, may allow for the integration of the AC voltages detected by the current detecting part 100 to thereby provide the peak value.

Next, the A/D converting part 300 may convert the voltage from the peak value detecting part 200 into a digital signal and may provide the digital signal to the driving controlling part 400.

Further, the driving controlling part 400 may drive the motor 60 for the initial driving period AT from motor driving initiation until a time at which a predetermined amount of motor revolutions is reached, to compensate for an offset in the motor driving current based on the digital signal from the A/D converting part 300.

As an example, when the driving controlling part 400 includes a pulse width modulation (PWM) controller 410 and a gate driver 420, the PWM controller 410 may control the driving of the motor 60 for the initial driving period AT and compensate for an offset in the motor driving current with a previously set offset compensation value corresponding to a magnitude of the digital signal from the A/D converting part 300. Further, the gate driver 420 may generate a gate signal according to the controlling of the PWM controller 410 and provide the gate signal to the inverter 50.

Since the motor has gate signals and driving current characteristics according to types thereof, such as a single phase type motor, a three phase type motor, or the like, the inverter 50 is employed so as to correspond to the types of the motor 60, thereby appropriately supplying the driving current required to drive the motor 60.

Meanwhile, as a method of setting the offset compensation value corresponding to the magnitude of the digital signal from the A/D converting part 300, the offset compensation value may be set to correspond to the magnitude of each digital signal previously input from the A/D converting part 300 using a look-up table 405.

In another method, a relational expression between the magnitude of the digital signal input from the A/D converting part 300 and the offset compensation value may be previously defined and the offset compensation value may be set to correspond to the magnitude of the digital signal from the A/D converting part 300 using the relational expression.

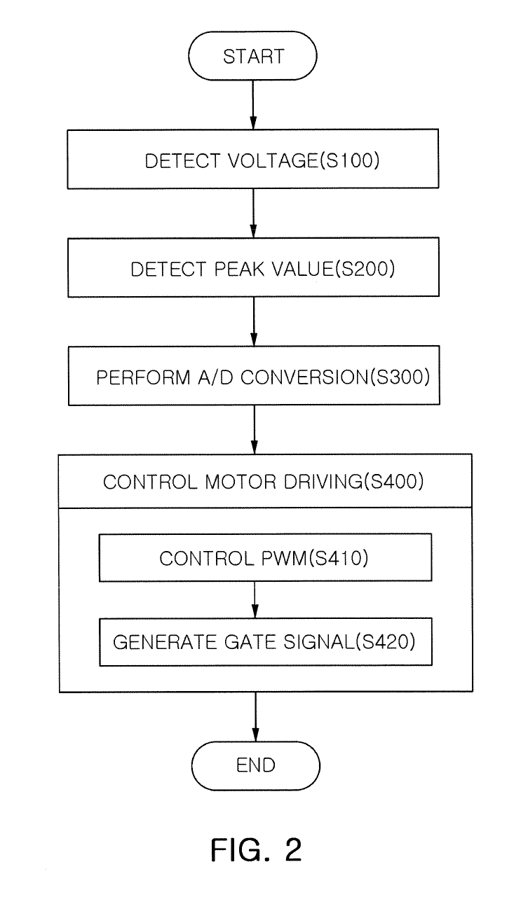

FIG. 2 is a flowchart illustrating a method of driving a motor according to a second embodiment of the present invention.

Referring to FIG. 2, a method of driving a motor according to the second embodiment of the present invention may include detecting a voltage corresponding to a driving current flowing in the motor 60 through the inverter 50 supplying the driving current to the motor 60 in operation S100, detecting a peak value of the detected voltage in operation S200, performing A/D conversion by converting the detected voltage into a digital signal in operation S300, and controlling driving of the motor by driving the motor 60 for a predetermined initial driving period AT from motor driving initiation until a time at which a predetermined amount of motor revolutions is reached, and compensating for an offset in the driving current based on the digital signal in operation S400.

First of all, the inverter 50 supplies a driving current to the motor 60 for a predetermined initial driving period ΔT, such that the motor 60 is driven. Here, the initial driving period ΔT may be a period from motor driving initiation until a time at which a predetermined amount of motor revolutions is reached. For example, the revolution of the motor 60 necessary for offset compensation may be at least one revolution, and therefore, two or three revolutions may be implemented.

In operation S100, a voltage corresponding to the driving current flowing in the motor 60 may be detected through the inverter 50 supplying the driving current to the motor 60.

As an example, in operation S100, the voltage Vd may be detected as Vd=Rd*Im, using a resistance value of the resistor Rd and the current Im flowing in the resistor Rd.

Next, a peak value of the voltage detected in operation S100 may be detected in operation S200.

Here, in the detecting of the peak value, the peak value may be detected by envelope detection or integration.

Thereafter, in operation S300, the detected voltage in operation S200 may be converted into a digital signal.

Further, in operation S400, the motor 60 maybe driven for the initial driving period ΔT from motor driving initiation until a time at which a predetermined amount of motor revolutions is reached, to compensate for an offset in the motor driving current based on the digital signal.

As an example, the controlling of driving of the motor (S400) includes controlling pulse width modulation (PWM) in operation S410 and generating a gate signal in operation S420.

In the controlling of PWM (S410), the driving of the motor may be controlled for the initial driving period ΔT and offset compensation may be performed with a previously set offset compensation value corresponding to a magnitude of the digital signal. Further, in the generating of the gate signal (S420), the gate signal may be generated according to the controlling of the PWM controller 410 and the generated gate signal maybe provided to the inverter 50.

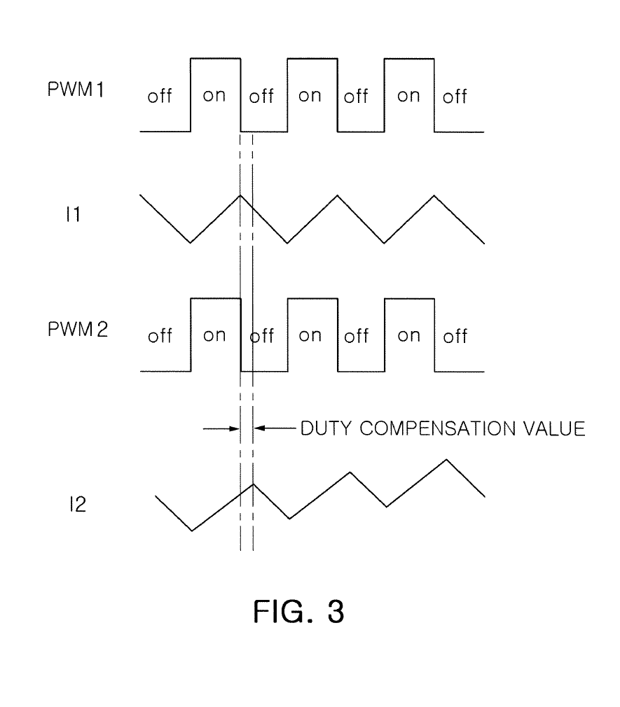

FIG. 3 is a waveform diagram illustrating a driving operation of the motor according to the first and second embodiments of the present invention.

In FIG. 3, PWM1 is a PWM signal before compensation, and Il is a driving current generated by the PWM signal PWM1. PWM2 is a compensated PWM signal, and 12 is a driving current generated by the compensated PWM signal PWM 2.

According to the embodiments of the present invention, referring to FIG. 3, as can be appreciated from I1 and I2, the related art process, in which offset compensation is not performed according to current distribution or drift in motor characteristics, provides the driving current I1 that is not subjected to the offset compensation according to the predetermined PWM signal PWM1, and as a result, it may be difficult to appropriately cope with current distribution or drift in motor characteristics.

On the other hand, in the embodiments of the present invention in which offset compensation is performed according to current distribution or drift in motor characteristics, the driving current I2 maybe provided according to the PWN signal PWM2 obtained by performing the offset compensation on the predetermined PWM signal PWM 1, and as a result, it maybe easy to appropriately cope with current distribution or drift in motor characteristics.

As described above, since the individual driving current is different at the time of manufacturing the motor and respective magnetic field characteristics may be distributed differently, an increase in a defect rate may occur when current distribution for motor samples is increased. In order to compensate for an offset due to current distribution, according to the related art, offset compensation needs to be performed using a resistor or a cap in an external driver controller, which may lead to greatly increased manufacturing time and costs due to manual processing.

According to the embodiments of the present invention, the motor is driven for the initial driving period from motor driving initiation until a time at which a predetermined amount of motor revolutions is reached to compensate for the offset in the motor driving current based on the detected driving current, thereby reducing current distribution and appropriately coping with drift in motor characteristics over time.

As set forth above, according to the embodiments of the present invention, an apparatus and a method of driving a motor provide initial compensation, thereby appropriately coping with motor characteristics variable whenever a motor is changed or while the driving of the motor is performed over time.

While the present invention has been shown and described in connection with the embodiments, it will be apparent to those skilled in the art that modifications and variations can be made without departing from the spirit and scope of the invention as defined by the appended claims.

What is claimed is:

1. An apparatus for driving a motor, the apparatus comprising:
a current detecting part detecting a voltage of a driving current flowing in the motor through an inverter supplying the driving current to the motor;
a peak value detecting part detecting a peak value of the voltage detected by the current detecting part;
an A/D converting part converting the voltage from the peak value detecting part into a digital signal; and
a driving controlling part driving the motor for a predetermined initial driving period to compensate for an offset in the driving current based on the digital signal from the A/D converting part.

2. The apparatus of claim 1, wherein the current detecting part includes a resistor connected between the inverter and a ground so as to detect the current flowing to the ground through the inverter, and detects the voltage determined by a resistance value of the resistor and the current flowing in the resistor.

3. The apparatus of claim 1, wherein the peak value detecting part includes an envelope detector detecting an envelope of AC voltages detected by the current detecting part to thereby detect the peak value.

4. The apparatus of claim 1, wherein the peak value detecting part includes an integrator integrating AC voltages detected by the current detecting part to thereby detect the peak value.

5. The apparatus of claim 4, wherein the peak value detecting part includes:
an operational amplifier having a first input terminal and a second input terminal receiving the AC voltages detected by the current detecting part; and
a capacitor connected between an output terminal of the operational amplifier and the second input terminal.

6. The apparatus of claim 1, wherein the driving controlling part includes:
a pulse width modulation (PWM) controller controlling the driving of the motor for the initial driving period and compensating for the offset in the driving current with a previously set offset compensation value corresponding to a magnitude of the digital signal from the A/D converting part; and
a gate driver generating a gate signal according to the controlling of the PWM controller and providing the gate signal to the inverter.

7. The apparatus of claim 1, wherein the initial driving period is a period from motor driving initiation until a time at which a predetermined amount of motor revolutions is reached.

8. A method of driving a motor, the method comprising:
detecting a voltage of a driving current flowing in the motor through an inverter supplying the driving current to the motor;
detecting a peak value of the voltage detected by the current detecting part;
performing A/D conversion by converting the voltage from the peak value detecting part into a digital signal; and
controlling driving of the motor by driving the motor for a predetermined initial driving period and compensating for an offset in the driving current based on the digital signal.

9. The method of claim 8, wherein the detecting of the voltage includes detecting the voltage determined by a resistance value of a resistor connected between the inverter and a ground and the current flowing in the resistor so as to detect the current flowing to the ground through the inverter.

10. The method of claim 8, wherein the detecting of the peak value includes detecting the peak value using an envelope of AC voltages.

11. The method of claim 8, wherein the detecting of the peak value includes detecting the peak value by integrating AC voltages.

12. The method of claim 8, wherein the controlling of the driving of the motor includes:
controlling pulse width modulation (PWM) by controlling the driving of the motor for the initial driving period and compensating for the offset in the driving current with a previously set offset compensation value corresponding to a magnitude of the digital signal; and
generating a gate signal according to the controlling of PWM and providing the gate signal to the inverter.

13. The method of claim 8, wherein the initial driving period is a period from motor driving initiation until a time at which a predetermined amount of motor revolutions is reached.
